(19) United States
(12) Patent Application Publication
(10) Pub. No.: US 2026/0269415 A1
(43) Pub. Date: Sep. 10, 2026

(54) Battery Cell Assembly

(71) Applicant: MONTAPLAST GmbH, Morsbach (DE)

(72) Inventors: Ralf Timme, Gärtringen (DE); Alexander Benz, Gerlingen (DE); Johannes Müller, Waldbröl (DE)

(21) Appl. No.: 19/166,876

(22) PCT Filed: Mar. 20, 2024
(86) PCT No.: PCT/EP2024/057457

§ 371 Date: Sep. 19, 2025

(30) Foreign Application Priority Data
Mar. 20, 2023 (DE) 10 2023 106 972.1
Jun. 2, 2023 (DE) 20 2023 103 045.9

(51) Int. Cl. H01M 50/293; H01M 10/658; H01M 50/213; H01M 50/249; H01M 50/291; H01M 50/507; H01M 50/588

(52) U.S. Cl. CPC H01M 50/293; H01M 10/658; H01M 50/213; H01M 50/249; H01M 50/291; H01M 50/507; H01M 50/588

(57) ABSTRACT

A battery cell arrangement including a battery tray 2 arranged on the underside in the installation position, designed to hold several battery cells 4 arranged next to each other, a battery cell holder 6 acting as a holding element with several battery cell receptacles designed to hold the battery cells 4 inserted into them, a contact carrier 10 arranged on top of the battery cells and comprising contacts for electrical connection to battery cells 4, and a casting resin 8 insertable into the battery tray 2 to enclose the battery cells 4 in the battery cell holder 6 and, if necessary, the contact carrier 10. To reduce throughput times, the battery cell holder 6 is designed as a shell-like battery cell holder shell open at one end, which has a closed holder plane that acts as a mounting surface and is spaced from the open end by a holder edge. The battery cell receptacles include battery cell holder jacket surfaces designed as stubs, and an intermediate section 61 is formed between two adjacent battery cell holder shell surfaces.

### I. FIELD OF THE INVENTION

The invention relates to a battery cell arrangement, in particular for a motor vehicle, comprising a battery tray arranged on the underside in the installation position and designed to accommodate several battery cells arranged next to each other, a battery cell holder acting as a retaining element and comprising several battery cell receptacles for accommodating battery cells that can be inserted into or are inserted into them. The battery cell holder positions the battery cells relative to one another in the battery cell receptacles when these are inserted into the battery tray or are already inserted therein. A bunch of battery cells inserted into the battery cell holders of the battery cell holder are electrically connected to the battery cells and an output line via a contact carrier that can be placed on top of the battery cells or is placed on top of them and has electrical contacts provided on it. Finally, a casting resin that can be poured into the battery tray that surrounds the battery cells in the battery cell holder and the contact carrier and fixes them in relation to each other.

### II. BACKGROUND OF THE INVENTION

A battery for an electric vehicle or an e-vehicle usually consists of several battery cells, comprising 200 battery cells and more, which are arranged in a battery cell arrangement.

When assembling such a battery cell arrangement, the individual battery cells, which usually have a cylindrical geometry, are inserted into the battery cell receptacles, i.e., the openings for receiving the battery cells within the battery cell holder. Preferably, the battery cell holder defines a holding plane in which the battery cell receptacles for receiving the battery cells are formed transversely to this holding plane. During assembly, one battery cell is inserted into a corresponding battery cell receptacle within the battery cell holder. The battery cell holder with the inserted battery cells is then inserted into the battery tray, which now surrounds and encloses the battery cells arranged at regular intervals from below and from the side.

The contact carrier is then placed on top of the battery cells, which is usually already equipped with metal connections for electrical contact with the battery cells. The contact carrier thus connects the battery cells to the electrical circuit of the battery cell arrangement.

Finally, a casting resin is poured into the battery tray, which, after hardening, encloses the battery cells and the battery cell holder like a block.

A central component of this battery cell holder arrangement is therefore the battery cell holder, which positions and holds the battery cells in relation to each other in the battery tray, while also spacing them apart and performing an important heat-insulating function between the individual battery cells.

Battery cell arrangements of this type are known from US 2020/0 127 350 A1, US 2021/0 184 190 A1 and DE 20 2018 102 801 U1.

Battery cell holders in the prior art are made of polyurethane due to its good thermal insulation properties, which also provides electrical insulation.

However, the manufacture of polyurethane battery cell holders is very time-consuming because these polyurethane parts require long cooling times of up to 10 minutes or more. Furthermore, the porous structure of this material limits the design options for battery cell holders. Polyurethane and components made from it have relatively low strength and elongation at break, meaning that thin components in particular can crack quickly when bent. As a result, the scrap rate in polyurethane production is relatively high and manufacturing can only be automated to a limited extent. Finally, polyurethane is not recyclable.

### III. SUMMARY OF THE INVENTION

Based on the prior art described above and the associated disadvantages, the invention is therefore aimed at least partially avoiding these disadvantages and, in particular, reducing the throughput times, i.e., the production times of such a battery cell arrangement.

This task is already solved by the features of the independent claims. Advantageous but not mandatory features are given in the subclaims.

In abstract terms, the battery cell holder is designed to provide thermal and electrical insulation between the battery cells it holds.

The electrical insulation is achieved by the battery cell holder being made of plastic and further being designed so that it surrounds the battery cells on all sides and holds them at a distance from each other.

Thermal insulation is achieved by providing intermediate sections and/or webs on the battery cell holder, which extend between adjacent battery cells when the battery cells are inserted into the battery cell holder and form heat-insulating air pockets in the intermediate sections or on the sides of the webs.

In the simplest embodiment, this is achieved by designing the battery cell holder essentially as a shell-like battery cell holder shell or -in short-as a holder shell, which comprises a closed holder shell surface and is spaced from the opening end by a holder shell edge that surrounds the holder shell surface. When inserted into the battery tray, i.e., in the installation position, this battery cell holder shell defines a closed closure end with the holder shell surface, on which a holder edge (battery cell holder edge) is formed, which extends completely around and transversely to the holder plane in the direction of the opening end. The holder shell surface also comprises the socket-shaped battery cell receptacles for holding the battery cells, preferably formed in one piece with it.

The casting resin completes this insulation. The sandwich construction of casting resin-battery cell holder-casting resin achieved in this way results in a particularly high rigidity of the entire arrangement. The insulating area is expandable and depends on the rigidity and weight of the entire battery structure.

The holder shell surface acts as a mounting surface for the battery cells, whereby an intermediate section is always formed between two battery cell receptacles that are close to each other, which is open at the opening end and closed at the holder shell surface or the closure end. The holder shell surface therefore has holder openings with battery cell holder jacket surfaces provided on them in the form of spouts, into which the battery cells can be inserted. Each holder opening therefore comprises a battery cell holder shell surface that completely surrounds the holder opening, extends in the direction of the opening end in the form of a spout, and is approximately as long as the holder edge.

The battery cell holder is therefore essentially shell-shaped as a “battery cell holder shell,” which defines a holder plane with the holder shell surface, which is enclosed and surrounded by a holder edge provided on this holder plane and extends transversely to the holder plane in the direction of the opening end. In the holder plane, holder openings are provided with battery cell holder jacket surfaces formed in a socket-like manner at each holder opening, into which the battery cells can be inserted, i.e., which are geometrically adapted to receive the battery cells. Each holder opening thus comprises, at a lower end facing the opening end, the battery cell holder shell surface which completely surrounds it, which also extends in the direction of the opening end and is approximately as long as the holder edge. The battery cell holder shell surfaces thus preferably form battery cell holder connectors, or simply “connectors,” which are integrally formed on the lower side of the holder shell surface of the battery cell holder and into which the battery cells can be inserted.

The battery cell holder thus encloses an air space defined by the holder shell (“holder shell space”), the size of which corresponds to the volume of the holder shell minus the volumes of the holder cell jacket surfaces. A distinction is made between two adjacent holder shell surfaces at the points where they are closest to each other, i.e., at the points where two imaginary radii of the two adjacent holder shell surfaces are collinear or extend collinearly. At this point, a minimum clearance is maintained, which is referred to as the “intermediate section” in accordance with the invention. This intermediate section also contains air.

The battery cell holder is thus designed as a shell or tray open at the opening end, wherein a shell base defines the holder plane and a shell edge provided on this shell base forms the holder edge.

The battery cell holder is inserted “upside down,” i.e., with the shell base facing upward and the opening end facing the battery tray. The shell base thus forms the upper side or the upper mounting plane with the battery cell receptacles formed therein and the shell edge at the edge of the shell base or the shell plane.

When this holder shell, equipped with the battery cells inserted into the battery cell receptacles, is inserted into the battery tray and the casting resin is poured into it, the air enclosed below the holder shell prevents the casting resin from penetrating into the holder shell space.

Depending on the viscosity of the casting resin used, an additional air gap may form between the plastic wall of the battery cell holder and the battery cell, which improves the thermal insulation. It may therefore be advantageous for the surface area of the battery cell holder jacket to be slightly larger than the outer dimensions of the battery.

According to the invention, the air enclosed under the holder shell is used as a heat insulator, which, by surprisingly simple means, enables significantly better heat insulation than the prior art. The invention thus takes advantage of the knowledge that air provides particularly good and inexpensive heat insulation.

According to the invention, the battery cell holder can be designed, for example, as a plastic injection molded part or a plastic thermoformed part (“deep-drawn part”), which are significantly more cost-effective than PUR foam, in particular because these cool injection molded parts or deep drawn parts cool down considerably faster (in less than 1 minute), thereby significantly reducing production throughput times. In addition, the material costs for injection molded parts or deep-drawn parts are significantly lower and they do not have to be manufactured in specialized plants. In this respect, the battery cell holder according to the invention can be integrated much better into existing production processes.

It goes without saying that the holder plane does not have to be straight, but can also be curved or have any other structure. It is important that, in the installation position, a mounting plane is formed which is spaced above the shell edge of the battery tray and in which air can be enclosed with the battery cells inserted in the holder shell space thus formed, preventing the ingress of casting resin during filling.

It is also clear to those skilled in the art that the shell plane or the shell edge does not necessarily have to be straight, but can also be curved, arched, or have other geometries.

In terms of design, the battery cell holder can be constructed from several battery cell receptacles connected to each other via the intermediate sections with a geometry adapted to the geometry of the battery cells. An intermediate section can be formed between two adjacent battery cell receptacles. Except at the edge areas, each battery cell receptacle is surrounded or enclosed by four intermediate sections. In the edge area, the battery cell holder is bounded or enclosed by the holder edge. The battery cell holder thus comprises several, preferably adjacent, battery cell receptacles, between which intermediate sections are formed, preferably from several rows and lines of battery cell receptacles, which then form a battery cell grid.

The intermediate section can therefore be formed between two adjacent outer walls of the battery cell receptacles. These outer walls of the often circular or hollow cylindrical battery cell receptacles form the facing inner walls of the intermediate sections.

At least in the area of battery cell receptacles spaced close together with the facing battery cell holder shell surfaces, a clear space or an internal distance may be formed to create the intermediate section, which is also filled with air.

For conventional battery cells, it has proven sufficient for the intermediate section or clear distance to be at least 1 mm. However, for larger battery cells, a larger internal distance may also be appropriate because a larger distance provides better thermal insulation.

Thanks to the design according to the invention, air is also enclosed in the intermediate sections when the casting resin is poured into the battery tray, thus providing the necessary thermal insulation between the adjacent battery cells.

An intermediate section can therefore be formed between two adjacent battery cell holders, which is closed at one end and has an inlet opening at the opposite end. Air can enter the intermediate section through the inlet opening and is enclosed in the intermediate section or sections when they are filled with casting resin. The intermediate section thus forms an air-filled air pocket that provides particularly good thermal insulation between the battery cells.

The intermediate sections can be pocket-shaped or channel-shaped.

The battery cell holder preferably has several battery cell receptacles, preferably several battery cell receptacles arranged in rows and columns to form a grid of battery cell receptacles, with an air-enclosing intermediate section provided between adjacent battery cell receptacles.

The battery cell holders can be formed in regular structures in the battery cell holder, but can also be arranged or formed in irregular structures.

For the thermal insulation according to the invention, it has proven sufficient that the intermediate sections have a clear interior space of 1 mm, i.e., a distance from the outer side of a first battery cell holder shell surface to an outer side of a second, adjacent battery cell holder shell surface.

To improve thermal insulation, the intermediate section, i.e., the distance, may also be larger.

Since air has a significantly better thermal insulation value than polyurethane, the invention achieves the necessary thermal insulation with significantly simpler means than the prior art, using a relatively simple and inexpensive plastic that can be injection molded or thermoformed to bring it into the desired shape. Furthermore, the battery cell holder always provides good electrical insulation between two adjacent battery cells via the plastic, also due to the completely closed battery cell holder defect surfaces.

The design according to the invention also allows significantly more delicate geometries to be realized compared to the prior art, such as locking mechanisms, i.e., locking tabs, locking ribs, locking lugs, snap hooks, domes or thin wall thicknesses of even less than 0.5 mm in the manufacturing process on the battery cell holder, which was not possible with the previous battery cell holders made of polyurethane. Due to the material properties, these required a minimum wall thickness of 2.5 mm, which considerably limited the design options.

The plastic used to manufacture the battery cell holder is still lightweight, but has significantly better elongation at break than polyurethane battery cell holders, while also being less expensive, as PUR is relatively expensive. According to the invention, a safe process with a high degree of automation and design freedom, low reject rates, and good break resistance can be achieved.

Since the battery cell holder is made of plastic, preferably injection molded or thermoformed, it must cool for a maximum of 1 minute, but usually significantly less, which considerably reduces throughput times and thus manufacturing costs compared to the state of the art.

Preferably, the pocket-or channel-shaped intermediate section has a width that is significantly less than its height.

To simplify the insertion of the battery cells into the battery cell holders, the intermediate sections can be tapered from the opening end to the top of the holder shell so that the surface of the battery cell holder does not lie flat against the battery cell everywhere.

For the same purpose, however, it is also possible for the battery cell holder receptacles with the battery cell holder outer surface to be slightly larger than the outer geometry of the battery cells to be accommodated.

Particularly good results in terms of thermal insulation are achieved when the ratio of the inner distance between the inner walls of the intermediate sections to the height of the at least one intermediate section, i.e., the distance from the entry end to the closure end, is approximately 9/100.

It is advantageous for the at least one intermediate section to have a significantly greater intermediate section height (distance from the entry end to the closure end) than the intermediate section width. Particularly good results were achieved when the intermediate section height is eight to ten times greater than the intermediate section width.

To reduce scrap due to incorrect installation and to enable the battery cell holder to be installed in any orientation, the opening end of the battery cell holder can be closed by a sealing film.

This is particularly easy to manufacture if this sealing film is applied to the entire opening end of the battery cell holder so that the openings of the battery cell receptacles are also sealed by the sealing film.

For assembly, the battery cells simply need to be inserted into the battery cell receptacles and pressed through the sealing film. However, the cells can also be inserted from below, which has the additional advantage that the separated sealing film adheres to the inner surface of the battery cell receptacles, improving thermal insulation.

To simplify assembly and create a defined opening in the sealing foil, the sealing foil can be pre-perforated in the area of the battery cell receptacles.

It is particularly useful to provide the pre-perforation in the geometry of cake pieces above the battery cell receptacles, whereby the pre-perforations extend along at least two, preferably several diagonals to the battery cell receptacle, which are arranged at offset angles to each other and intersect at a common center point.

The provision of the sealing film also increases the thermal insulation because the sealing film provides additional thermal insulation and electrical insulation in addition to the intermediate section.

The sealing film also allows for an even more compact design of the battery cell holder with narrower webs that do not form air pockets, so that the heat-insulating air pockets are not provided within the intermediate sections, but between the outer surface of the battery cells and the inner side of the battery cell receptacles. Here, the sealing film also serves to prevent the casting resin from penetrating into the space between the battery cells and the battery cell holders.

The sealing film can be applied to the top and, if necessary, also to the bottom of the battery cell holder, which then deforms when the battery cells are inserted into the battery cell opening, thus forming an air-trapping sealing lip between the battery cell and the partition wall of the battery cell holder, which prevents casting resin from entering the space between the battery cell and the wall during filling and traps air below the film, thus forming a complete air pocket between the battery cell and the battery cell holder.

For defined bending of the sealing film around the entire circumference when inserting the battery cells, additional holes may be provided in the sealing film, which are preferably formed centrally with respect to the battery cell receptacles.

The film can be provided on the surface of the holder shell or on the underside of the holder shell, possibly also on both surfaces, but is particularly preferred on the upper side of the holder shell.

The sealing film can be made of polyethylene (PET), for example. Depending on the application, it can have different material thicknesses, but is preferably designed as a construction film with a greater material thickness of 100-30 μm (my). In special cases, a particularly stable film, such as HDPE pond film, is also conceivable.

The contact carrier is therefore preferably designed to connect to the negative and positive poles of the battery cells. For this purpose, it preferably comprises a plastic contact carrier and metallic contact elements that are connected to conductors in the contact carrier and thus to the electrical connection.

In an alternative embodiment, the battery cells can also be electrically connected via the battery tray, in particular via the negative pole.

It is understood that particularly good thermal insulation and electrical insulation are achieved by forming an intermediate section between adjacent battery cell receptacles of the battery carrier, i.e., the battery carrier comprises several intermediate sections, each in the area of adjacent battery cell receptacles.

The battery cell holder, like the battery tray and the contact carrier, is preferably designed as a single-piece plastic part. Plastics with low moisture absorption have proven to be particularly suitable for the manufacture of the battery cell holder.

Even better thermal insulation can be achieved by filling the holder shell with polyurethane foam (PUR foam) or another suitable heat-insulating material. This provides particularly good thermal insulation, with electrical insulation continuing to be provided by the plastic of the battery cell holder carrier.

Compared to the prior art, the battery cell holder according to the invention has significantly better dimensional stability and higher dimensional tolerances.

The casting resin can be filled to enclose either only the battery cells and the battery cell holder or also the contact carrier up to approximately half its height.

### IV. BRIEF DESCRIPTION OF THE DRAWINGS

The following detailed description of the figures refers to the accompanying drawings, which form part of this description of the invention and illustrate specific embodiments with which the invention can be carried out. In this regard, directional terminology such as “top,” “bottom,” “front,” “back,” “front,” “rear,” etc. is used in relation to the orientations of the figure(s) described. Since components of embodiments may be positioned in a number of different orientations, the directional terminology is for illustrative purposes only and is in no way limiting. It is understood that other embodiments may be used and structural or logical changes may be made without departing from the scope of the present invention. The following detailed description is not to be construed in a limiting sense.

Within the scope of this description, the terms “combined,” “connected,” and “integrated” are used to describe both a direct and an indirect connection, and a direct or indirect integration.

Unless otherwise specified, the indefinite article and the definite article do not refer to a single component, but are to be understood as “at least one.” The terminology includes the aforementioned words, variations thereof, and similar meanings. Furthermore, it should be understood that the terms “approximately,” “essentially,” and similar terms in connection with the dimensions and a property of a component of the invention do not describe the described dimension and property as a strict limit or parameter and do not exclude minor variations thereof that are functionally similar. At a minimum, parts of the description containing numerical parameters also include variations of these parameters in accordance with mathematical and manufacturing principles in the state of the art, e.g., rounding, deviations, and other systematic errors, manufacturing tolerances, etc.

Identical or similar elements in the figures are assigned identical reference symbols, where appropriate. Identical reference numbers in the figures therefore refer to identical components or features.

Reference lines are lines that connect the reference symbol to the relevant part. An arrow that does not touch any part, on the other hand, refers to an entire unit to which it is directed.

The representations in the figures are not necessarily to scale. Certain areas may be exaggerated in size for illustrative purposes. Furthermore, the drawings may be simplified for clarity and may not include every detail that may be present in the practical implementation.

All features of the respective embodiment are here disclosed independently of other features of the respective embodiment. Likewise, the features mentioned above and those described in more detail can be used individually or in any combination according to the invention. The embodiments shown and described are not to be understood as an exhaustive list of, but rather are examples for the description of the invention.

Shown:

FIG. 1 a schematic side view of a battery cell arrangement according to the invention;

FIG. 2 an enlarged schematic sectional view of two battery cells arranged side by side in the battery cell arrangement;

FIG. 3 a smaller side view of the side sectional view according to FIG. 2 without battery cells;

FIG. 4 the enlarged section IV according to FIG. 3 of the lower end of an intermediate section with the casting resin arranged thereunder;

FIG. 5 an isometric view of a battery cell holder from below;

FIG. 6 an isometric top view of the upper closure end of the battery cell holder;

FIG. 7 an isometric view of the battery cell holder from below;

FIG. 8 an enlarged side sectional view of a second embodiment of a battery cell holder with a closure film on the opening end;

FIG. 9 an enlarged isometric top view of the underside of the battery cell holder closed with the sealing film according to FIG. 8;

FIG. 10 a top view of the sealing film to illustrate a pre-perforation in the area of the battery cell receptacles;

FIG. 11 a side sectional view of a third embodiment of the battery cell holder according to the invention filled with PUR foam;

FIG. 12 An enlarged isometric view of the battery cell holder filled with PUR foam according to FIG. 11 from below;

FIG. 13 an enlarged side sectional view of a third embodiment of a battery cell holder with a sealing film with film holes on the opening end; and

FIG. 14 is a top view of a section of the battery cell holder with the sealing film with film holes used in FIG. 13.

### V. DETAILED DESCRIPTION OF THE INVENTION

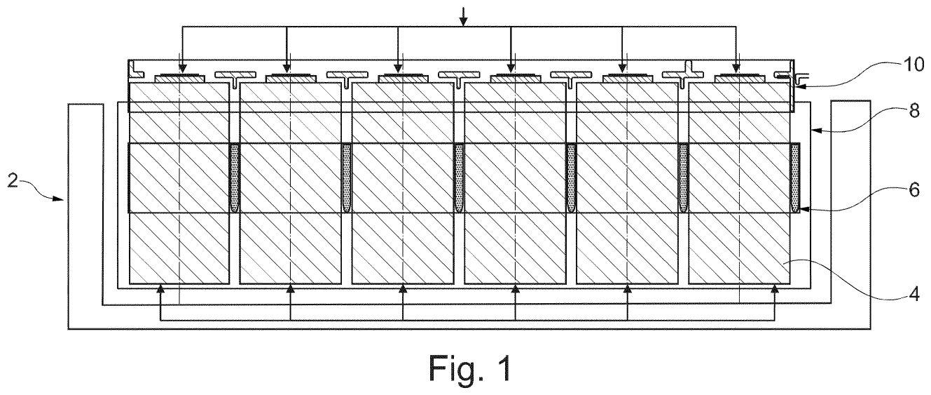

FIG. 1 shows the schematic structure of a battery cell arrangement according to the invention in a longitudinal section, which essentially consists of a tray-like battery tray 2, a plurality of battery cells 4 arranged therein, a battery cell holder 6 holding these, a contact carrier 10 arranged on top of the battery cells 4, and a casting resin 8 filled into the battery tray 2, which surrounds or encloses the battery cells 4, the battery cell holder 6 and, up to about half the height, the contact carrier.

When installed in the motor vehicle in its installation position, the battery tray 2 forms the tray-shaped lower part and comprises a base section defining a base plane, on which side parts or an edge extending transversely to the plane of the base section are integrally formed on all sides or around the perimeter to form the battery tray 2, which is closed on all sides and in which the battery cells 4 and the battery cell holder are arranged.

In this battery tray 2, several battery cells 4 (only one designated; in this example, 200 pieces) are arranged to form a battery cell grid, and are inserted into battery cell receptacles in the battery holder 6, which are designed to correspond to the battery cells 4 and are, in this case, ring-shaped.

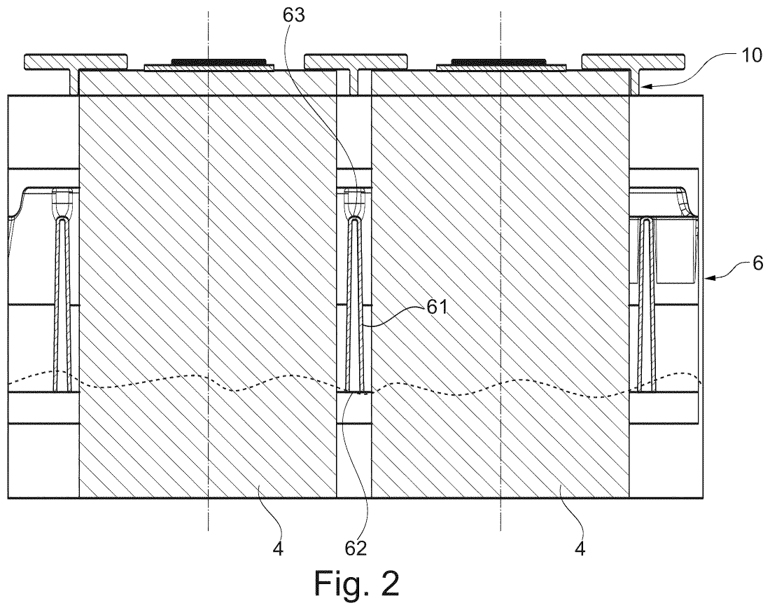

FIG. 2 shows an enlarged, schematic sectional side view of two battery cells 4 inserted into the battery cell holder 6 and enclosed with casting resin 8 with a contact carrier 10 attached. It can be clearly seen how the pocket-shaped intermediate sections 61 are formed in the battery cell holder 6 in the area between two adjacent battery cell receptacles, which define internal air pockets.

At the opening end located at the bottom in the installation position, the shell-or trough-shaped battery cell holder 6 is open and closed at the opposite end, the holder shell surface 65, so that a “battery cell holder tray” is formed in the overall structure. A holder edge is integrally formed along the entire side edge, enclosing or surrounding the holder shell surface 65 and extending transversely to the holder plane in the direction of the opening end.

Holder openings are formed in the holder shell surface 65, into which the battery cells 4 can be inserted. Each holder opening also comprises a battery cell holder jacket surface 64, which completely surrounds the holder opening and extends in the direction of the opening end, is, in the present case, designed as a socket, is approximately as long as the holder edge, and forms the battery cell receptacles.

Thus, extending toward the opening end, there are several hollow cylindrical battery cell holder shell surfaces 64 for receiving the correspondingly designed battery cells 4. These battery cell holder shell surfaces 64 are designed as hollow cylinders, but can have any geometry, including variable geometries, that are adapted to accommodate the corresponding battery cells.

FIG. 5 shows an isometric view of the battery cell holder 6 from below.

Where the battery cell holder shell surfaces 64 are closest to each other, a downwardly open, pocket-shaped intermediate section 61 is formed at two collinearly extending radii of the battery cell holder surfaces between two adjacent battery cell holder shell surfaces 64 that is formed by the outer walls of the two adjacent battery cell holder shell surfaces 64.

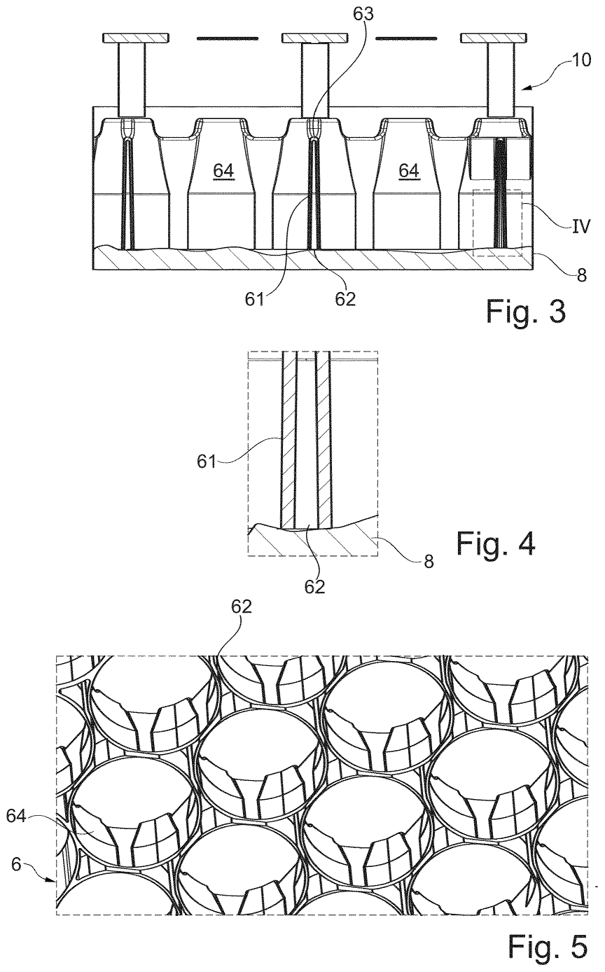

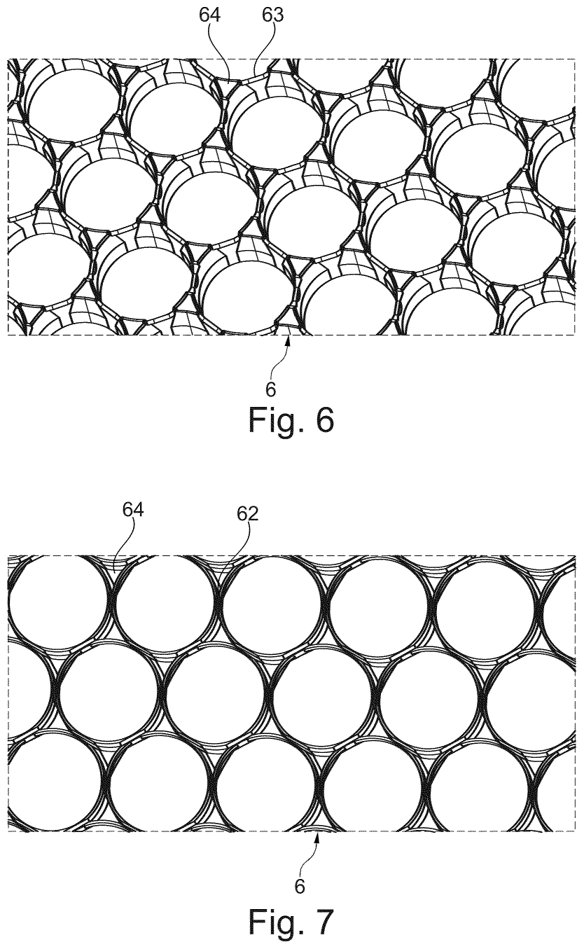

As shown in FIGS. 3 and 4, the inner distance or clear distance of this intermediate section 61 from the lower entry opening 62 to the closed end in the holder plane may taper slightly. In addition, the wall thickness may vary.

In the present preferred embodiment, the ratio of the inner distance to the height of the intermediate section 61 is approximately 9/100, but the inner distance is approximately 1 mm.

The height of an intermediate section 61, i.e., the intermediate section height from the entry opening 62 to the closure end 63, is 8-12 times greater than the intermediate section width, preferably 10 times greater.

The holder shell surface 65 forming the holder plane may be located slightly above or below the closure end 63 of the intermediate sections 61.

To facilitate insertion and removal of the battery cells, the side walls of the intermediate section 61 may converge at a slight angle. The intermediate sections thus form an air pocket closed at the top at the closure end 63 in the area of the adjacent battery receptacles, with the inlet opening 61 for the air at the lower end in the installation position. Such an intermediate section 61 is formed at each of the narrowest points of the battery cell holder 6 between two adjacent battery cell holder shell surfaces 64, i.e., where the radii of two adjacent battery cell holder shell surfaces are collinear.

The contact carrier 10 is placed on top of the battery cells 4 at a distance from the battery cell holder 6 so that it can enclose the battery cells 4 laterally i.e., with a horizontal section resting on the top of each of the battery cells 4 and with a vertical section extending transversely to this horizontal section resting on the outer surface of the battery cells 4.

The contact carrier 10 accommodates metal contact elements, which are not shown in detail, which are connected to the terminals of the battery cells 4, i.e., are electrically connected to the positive and negative poles of the battery cells 4 and conduct the current to a connecting line.

Alternatively or additionally, connections may also be provided in the battery tray 2, preferably for the negative pole.

In particular, the side sectional views in FIGS. 3, 4, and 8 show how the intermediate sections 61 are formed between two adjacent battery cell holder shell surfaces 64 of two battery cell holders.

Due to the arrangement of the battery cell holder 6 equipped with the battery cells 4 in the battery cell receptacles with the opening end facing downwards in the battery tray 2, air is enclosed in the air space enclosed below the battery cell holder 6 when the battery tray 2 is filled with casting resin 8, in particular also in the narrow intermediate sections 61, i.e., the space defined by the narrow sections of two adjacent battery cell receptacles, thus forming air pockets for thermal insulation between the adjacent battery cell receptacles 64.

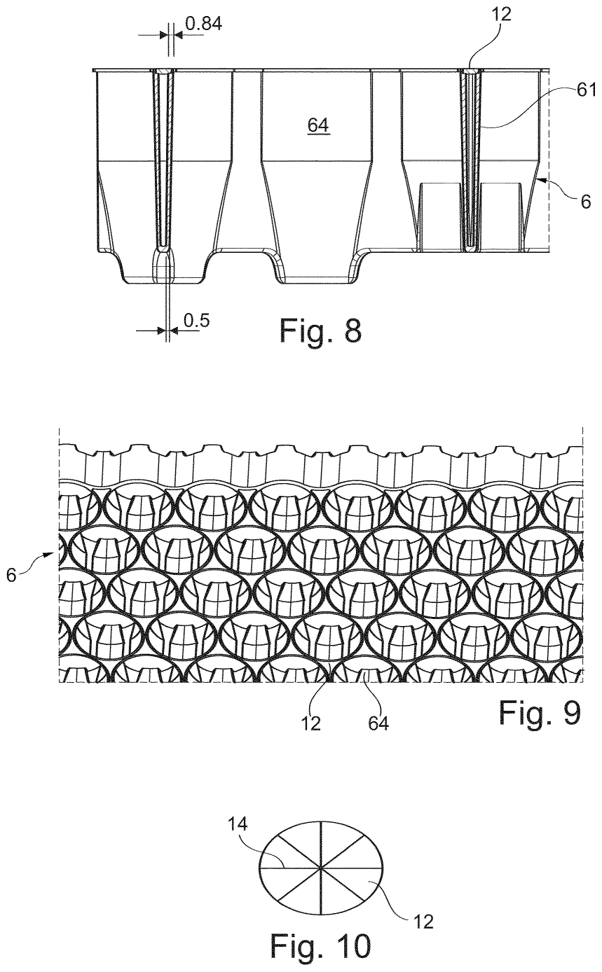

In the second embodiment of the battery cell holder 6 shown in FIGS. 8 and 9, the opening end of the otherwise identically constructed battery cell holder 6 is provided with a continuous sealing film 12, which thus closes the open underside of the battery cell holder 6.

In order to facilitate removal of this sealing film 12 when the battery cells 4 are pressed into the battery cell receptacles, this sealing film 12 may be pre-perforated in the area of the opening of the battery cell receptacles, as shown in FIG. 10 for example for the sealing film in the area below a battery cell receptacle.

In fact, the sealing film 12 in FIG. 10 is only shown as an example for a section in the area of a battery cell receptacle in order to illustrate the course of the perforation lines 13 of the pre-perforations. Such perforation lines 13 according to FIG. 10 are preferably provided in the area of all battery cell receptacles on the sealing film 12.

In the present preferred embodiment, the perforation lines 13 run along several diagonals extending at offset angles to each other to the respective battery cell receptacle, which intersect at a point, i.e., similar to “pie slices.” Thus, when the battery cells 4 are inserted into the battery cell receptacles, the sealing film 12 is separated at the perforation lines 13 but does not detach from the battery cell holder 6.

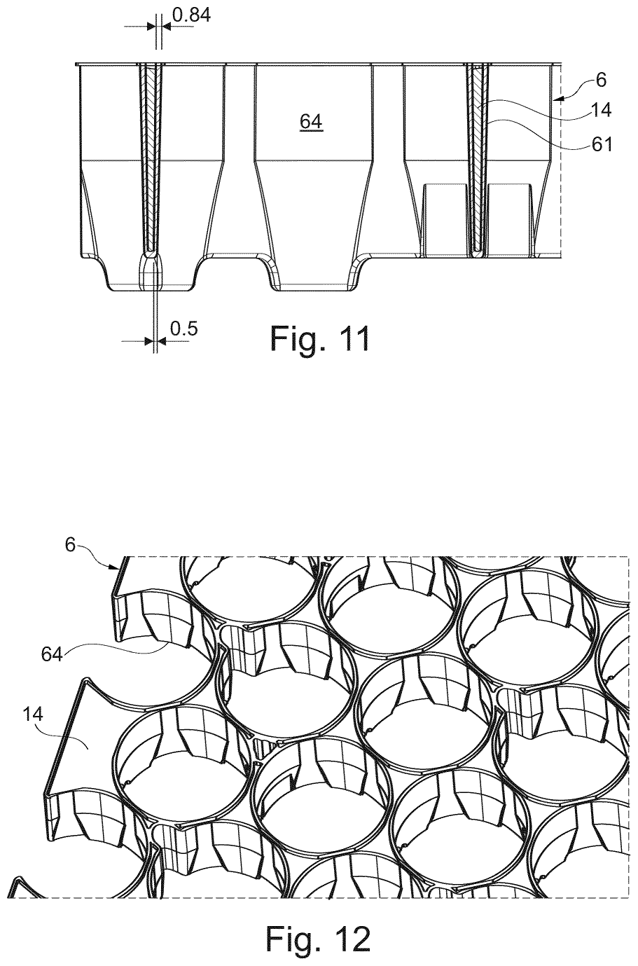

FIGS. 11 and 12 then show a third embodiment of the battery cell holder 6, the opening end being filled with PUR foam 14, which thus fills all the spaces between the shell surfaces 64 of the battery cell receptacles, i.e., also the intermediate sections 61, as can be seen from the cross-section according to FIG. 11. Like the second embodiment, this third embodiment can also be arranged in the opposite direction in the battery tray 4, i.e., with the open end of the battery cell holder 6 facing upwards. Despite being filled with PUR foam, which takes a long time to cure, this embodiment also has the advantage of short throughput times, because the PUR foam is filled into the battery cell holder 6 for curing and can dry in it during further processing. It is therefore not necessary to wait for complete curing before further processing.

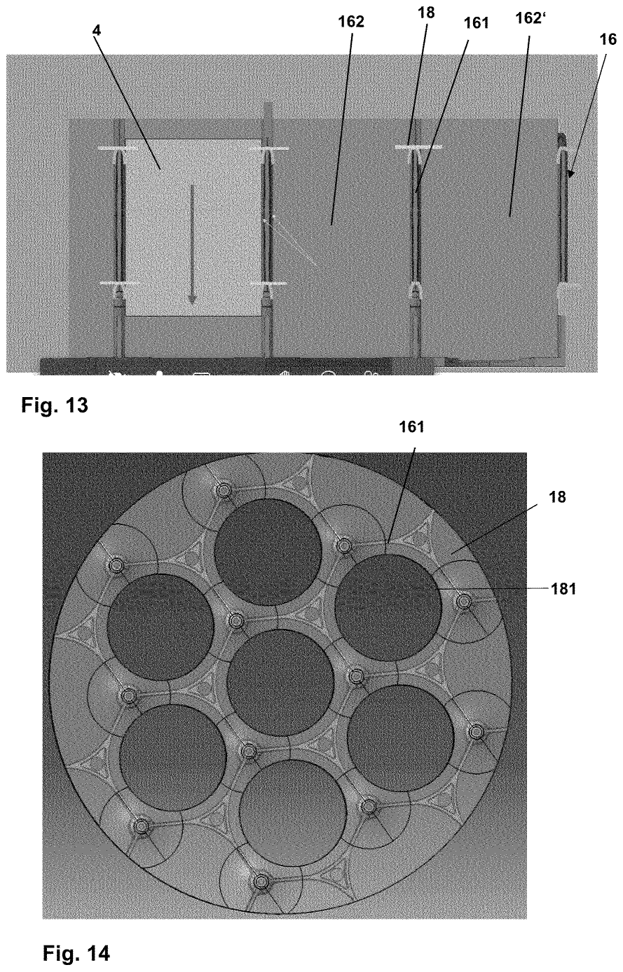

FIG. 13 shows an enlarged side sectional view of a third embodiment of a battery cell holder 16 with partition walls or areas between two adjacent battery cell holder jacket surfaces 162 between the sealing foil and the webs 161. In this embodiment, a sealing film 18 is also arranged on the upper side of the battery cell holder 16 in the installation position. This battery cell holder 18 differs from the previously described embodiments in that the partition walls between the battery cell holder deflection surfaces forming the battery cell receptacles are not pocket-shaped, i.e., they do not form air pockets, but are continuous webs 161 which are therefore not hollow on the inside. These webs 161 of the battery cell holder 16 thus separate the cylindrical battery cell holder shell surfaces 182 from one another.

As can be seen in FIG. 14, which shows an enlarged top view of the embodiment of the battery cell holder according to FIG. 13 with the sealing foil 18 applied, either before the sealing foil is connected to the upper side of the battery cell holder 18, or after the sealing foil 18 is applied, several foil holes 181 are formed in the sealing foil 18, which, in the installation position, i.e. after the sealing foil 18 has been connected to the battery cell holder 16, are arranged approximately in the center of the battery cell receptacles.

When the battery cells 4 are inserted into the battery cell receptacles of the battery cell holder 16, the sealing foil 18 (illustrated in FIG. 13) bends downwards around the perimeter into the battery cell receptacles, thereby enclosing air with the upper side of the sealing foil 18 so that air pockets are formed around the perimeter of the battery cells and between the battery cell receptacles and the battery cell holder jacket surfaces 162.

In summary, the battery cell arrangement comprises a battery tray 2 arranged on the underside in the installation position and designed to accommodate several battery cells 4 arranged next to each other, a battery cell holder 6 acting as a retaining element with several battery cell receptacles for accommodating battery cells 4 inserted or insertable into these, a plurality of battery cells 4 inserted into these battery cell receptacles, a contact carrier 10 arranged on the upper side of the battery cells and comprising contacts for electrical connection to battery cells 4, and a casting resin 8 which can be poured into the battery tray 2 to enclose the battery cells 4 in the battery cell carrier and, if necessary, the contact carrier 10.

To reduce throughput times, the battery cell holder 6 is designed as a shell-like battery cell holder shell open at one end, which has a closed holder shell surface 65 and is spaced from the open end by a closed holder edge which extends around the circumference or forms, such that the battery cell receptacles comprise spout-like battery cell holder shell surfaces 64 for inserting the battery cells 4, and such that an intermediate section 61 is formed between two adjacent battery cell holder shell surfaces 64, which, together with the surrounding casting resin, forms an air pocket which provides particularly good thermal insulation between adjacent battery cells.

The subject matter of the present invention is not only apparent from the subject matter of the individual patent claims, but also from the combination of the individual patent claims with each other. All information and features disclosed in the documents, including the summary, in particular the spatial configuration shown in the drawings, are claimed as essential to the invention insofar as they are new individually or in combination compared to the prior art.

### LIST OF REFERENCE SIGNS

2 Battery tray
4 Battery cell
6 Battery cell holder
61 Intermediate section
62 Entry opening
63 End of closure
64 Battery cell holder shell surfaces
65 Holder shell surface
8 Casting resin
10 Contact carrier
12 Sealing foil
13 Perforation lines
14 PUR foam
16 Battery cell holder
161 Web
162 Battery cell holder jacket surface
18 Sealing foil
181 Film hole

1. A battery cell arrangement, comprising:
a battery tray arranged in an installation position at a lower end and configured to accommodate a plurality of battery cells;
a battery cell holder configured to act retaining element with several battery cell receptacles formed therein for receiving battery cells (4) inserted into battery cell receptacles;
battery cells that can be inserted or are inserted into the battery cell receptacles of the battery cell holder;
a contact carrier placed on a top of the battery cells, inserted into the battery cell holder, or placed on top of the battery cell holder and/or the battery cells, the contract carrier having contacts for electrical contact with the battery cells; and having contacts for electrical contact with the battery cells
a casting resin enclosing the battery cells and arranged in the battery tray by the battery cell holder, and
wherein
the battery cell holder is having a closed holder shell surface and
is spaced from an opening end by a retaining edge that extends around the circumference and is closed,
the battery cell receptacles include spout-like battery cell holder jacket surfaces for inserting the battery cells, and
between two adjacent battery cell receptacles there is an intermediate section (61) providing an intermediate spacing, which is open toward the opening end and closed at the holder shell surface

2. The battery cell arrangement according to claim 1, wherein at least one intermediate section is designed in a pocket or channel shape.

3. The battery cell arrangement according to claim 1, wherein least one intermediate section is formed by outer surfaces of two adjacent battery cell receptacles, and a minimum clear distance of the intermediate section is located where a radii of the outer surfaces of the two adjacent battery cell receptacles are collinear.

4. The battery cell arrangement according to claim 3, wherein intermediate section and/or the battery cell receptacle tapers or is reduced from the entry opening toward the holder plane.

5. The battery cell arrangement according to claim 4, wherein the ratio of a clear distance of the intermediate section to a height of the intermediate section (61) is 9/100.

6. The battery cell arrangement according to claim 1, wherein the intermediate section has a clear distance at least 1 mm.

7. The battery cell arrangement according to claim 1, wherein at least one intermediate section has an intermediate section height that is significantly greater than an intermediate section width.

8. The battery cell arrangement according to claim 7, wherein the intermediate section height is 8 to 10 times greater than the intermediate section width.

9. The battery cell arrangement according to claim 1, wherein the opening end of the battery cell holder is completely or partially closed by a sealing film.

10. The battery cell arrangement according to claim 9, wherein the sealing film includes a pre-perforation with perforation lines in the region of the battery cell receptacles.

11. The battery cell arrangement according to claim 10, wherein perforation lines are formed like the cutting lines of cake pieces.

12. The battery cell arrangement according to claim 1, wherein the contact carriers are configured for connection to the positive and negative poles of the battery cells.

13. The battery cell arrangement according to claim 1, wherein battery tray configured for electrical connection to the battery cells.

14. The battery cell arrangement according to claim 1, wherein a plurality of the at least one intermediate sections are formed between adjacent battery cell receptacles.

15. The battery cell arrangement according to claim 1, wherein battery cell holder includes at least one wall, and each wall has a wall thickness and a minimum thickness of the wall thickness is 0.5 mm.

16. The battery cell arrangement according to claim 15, wherein wall thickness of the battery cell holder varies in different areas.
